(19) United States
(12) Patent Application Publication
(10) Pub. No.: US 2003/0144402 A1
(43) Pub. Date: Jul. 31, 2003

(54) Blends of polyamide and polyester for barrier packaging

(76) Inventor: Timothy Tyler Schenck, Wilmington, DE (US)

Correspondence Address: TYLER SOLUTIONS LLC, 420 TWADDELL MILL ROAD, CENTREVILLE, DE, 19807, US

(21) Appl. No.: 10/248,077

(22) Filed: Dec. 16, 2002

Related U.S. Application Data
(60) Provisional application No. 60/340,108, filed on Dec. 17, 2001.

(51) Int. Cl. C08G 63/91; B32B 27/08; C08K 3/34

(52) U.S. Cl. 524/445; 428/475.5; 428/479.3; 525/425

(57) ABSTRACT

A polymer composition comprising a blend of amorphous nylon copolymer and polyester that is useful in packaging applications where good barrier properties are desired. These compositions can be effectively processed using methods including extrusion blow molding and extrusion coating. When incorporated as a layer in a package, these blends exhibit good gas barrier properties and a reduced tendency to absorb flavor from a packaged product. These blends exhibit a combination of processibility and properties that is difficult to achieve with polyester alone.

### BACKGROUND OF INVENTION

This invention relates to blends of polyamide and polyester, specifically to blends that provide good gas barrier and non-scalping performance when incorporated as a layer in a package. When packaging products such as food and beverages, it is desirable to provide a package that will protect the freshness and flavor of the product. For many food products, freshness can be preserved by preventing the permeation of oxygen into the product; this prevents oxidation of the food and the concomitant off-taste or spoilage that may occur. Thus, a package that provides a barrier against the permeation of gas is desirable. For some foods, an unwanted shift in flavor may occur if certain elements or “flavor tones” in the product are absorbed by the package. This absorption phenomenon is referred to as “scalping”. A package that does not absorb (or scalp) flavor components from the food is desirable. For carbonated beverages, such as soft drinks or beer, it is desirable to maintain the gas (carbon dioxide) within the product so that the beverage does not go “flat”. In this application, it is desirable to have a package that is a good barrier to the permeation of carbon dioxide. In fact, for beer, it is desirable to have a package that provides both a good barrier against the absorption of oxygen and the loss of carbon dioxide. A preferred packaging material that provides both a good barrier against gas permeation and non-scalping performance is glass; within practical limits, glass exhibits no permeation of gas and no absorption of flavor components from a packaged product. Packages made from metal, such as aluminum cans, also exhibit excellent barrier and non-scalping performance, although in some cases there may be interaction between the metal and the packaged product that affects taste. Since the mid 1950s there has been a dramatic growth in packages made from plastic and plastic and paper composites. These packages offer advantages such as lower weight, non-breakable, and lower cost versus glass or metal alternatives. Plastics in general, however, do not exhibit good barrier properties as compared to metal or glass. One measure of the gas barrier properties of common plastic materials is the oxygen permeation value (OPV) typically measured in the units, cc/100 in2/day/atm. OPV is inversely related to barrier performance; a higher OPV value indicates a lower resistance to the permeation of oxygen through the polymer. The following are OPV values, taken from the literature, for some common plastic materials used in packaging: LDPE—600, HDPE—220, Polypropylene—100-220, Polystyrene—318, Polycarbonate—260, PVC(rigid)—13, PET—2-12, nylon 6—1 -20, amorphous nylon—1-3, MXD6 nylon—0.1 -3, PVDC—0.16, EVOH—0.02-3. The oxygen barrier performance of plastics is dependent on many variables including fabrication method, thickness of the barrier layer, temperature, and moisture content. Thus, there are many different published values for OPV for any given plastic. The values listed here are representative but not definitive. The polyolefins (HDPE, LDPE, PP), polystyrene, and polycarbonate are generally considered to be poor barrier materials. The other materials listed are considered to be from fair to good barrier materials and are often selected when some degree of oxygen permeation protection is required in a package.

Polymers may be incorporated in packaging using many different fabrication methods. Some common packaging forms include film, coated paper, injection stretch blow-molded containers (ISBM), and extrusion blow-molded containers (EBM). Extrusion processes including film casting and the blown film process produce plastic film. The films may comprise one layer or many layers. Multi-layered films can be produced by coextrusion of two or more plastic materials through a single die. Plastic films can be used directly for packaging as in meat wrap or can be converted to pouches by folding the film and sealing the seams. Such pouches, or bags, can be used in various liquid and dry packaging applications. Often, single-layer or multi-layer plastic films are coated onto a paperboard substrate. The coated paperboard can then be formed into a number of package shapes. A familiar example is the “gable-top” carton that is used to package juice and milk. ISBM bottles are common. Most soft drink bottles, made from PET, are produced using the ISBM process. EBM bottles are also common and are used for many products including beverages, cleaning agents, and various dry products. Both ISBM containers and EBM containers may be one layer or multi-layered using a coextrusion process as described above. When some level of barrier performance is desired in a package, be it film, coated paper, or bottle, it is common practice to use a co-extruded plastic layer. For example, HDPE can be co-extruded with amorphous nylon (and a tie layer of polymer in between) to produce an EBM bottle for orange juice. A thick layer of (lower cost) HDPE provides strength and a thin layer of (higher cost) amorphous nylon provides oxygen barrier and non-scalping performance. This provides the desired bottle performance at lowest cost.

It is characteristic of many barrier polymers, in particular semicrystalline polymers such as nylon 6 and EVOH, that the OPV value increases as the moisture content increases. Amorphous nylon exhibits the reverse effect; OPV value decreases as the moisture content increases. A common application for amorphous nylon is as an internal layer in an extrusion blow-molded bottle for packaging beverages such as orange juice, as described above. In this application, the amorphous nylon offers very good oxygen barrier because it contacts the beverage and is at high equilibrium moisture. In contrast, although EVOH is one of the best barrier polymers in a dry environment, it is inferior when wet.

PET has been the material of choice for bottles for carbonated beverages. The combination of clarity, strength, barrier performance and low cost give it an advantage over other plastic materials. However, the advantages of PET can only be properly realized when the bottle is produced using the ISBM process. Attempts to produce a PET bottle utilizing the EBM process have not been commercially successful; PET is difficult to extrude in the EBM process and the resulting containers tend to be brittle and translucent. Certain modified forms of PET have been developed to improve processibility and properties when used in extrusion processes such as EBM and extrusion coating but the commercial acceptance has been limited. These materials include polyester copolymers and olefin-modified polyesters; for example, Selar PT resins from E. I. DuPont.

Various blends of barrier polymers have been described in the literature. DuPont literature describes blends of amorphous nylon (“Selar PA”) and nylon 6 and cites advantages such as higher clarity and improved oxygen barrier in a moist environment versus straight nylon 6. DuPont literature also describes blends of amorphous nylon with EVOH, and blends of amorphous nylon, ionomer and nylon 6, and EVOH. Advantages of these blends are said to include improved barrier in a moist environment and improved formability of sheets produced from these blends. BASF describes blends of 6,6/6 nylon and amorphous nylon; said blends are claimed to exhibit reduced curl when co-extruded in a film structure. Mitsubishi Gas Chemical describes blends of MXD6 nylon and nylon 6 and cites advantages including improved gas barrier and better thermoformability versus straight nylon 6. Blends of MXD6 nylon and amorphous nylon have been proposed. It is expected that these blends will exhibit good compatibility and clarity and a balance of properties that are average between the constituents. U.S. Pat. No. 5,707,750 describes blends of MXD6 nylon and EVOH, which are claimed to be useful in the manufacture of retortable films.

U.S. Pat. No. 4,501,781 describes a bottle-shaped container including a layer that is a mixture of PET and MXD6 nylon, said container offering superior gas barrier properties than if said layer was 100% PET. The concentration of MXD6 nylon in the layer should not exceed 30% by weight or problems of delamination may occur. U.S. Pat. No. 5,866,649 describes blends of polyester or polycarbonate, barrier polymer (preferably MXD6 nylon), and a transition metal catalyst. These blends are claimed to provide superior gas barrier and oxygen scavenging properties as compared with prior art. The barrier polymer concentration in the blend should be less than 10% by weight. U.S. Pat. No. 5,340,884 discloses polyamide concentrates where the polyamide can be either partially aromatic or aliphatic and should be of low molecular weight. These concentrates can be blended with polycarbonates, polyesters, polyolefins and combinations thereof to produce blends that are claimed to have excellent barrier properties and improved flavor retaining properties. The polyamide concentration in the blend should be between 0.05 and 2.0 weight percent

### SUMMARY OF INVENTION

This invention relates to blends of polyamide and polyester, specifically to blends of amorphous polyamide and polyester. When incorporated as a layer in a packaging structure, said blends provide a good barrier against gas transmission and a reduced tendency to absorb flavor components from the packaged product.

These blends can be processed using methods common to the packaging industry including extrusion coating onto a substrate, extrusion blow molding, and injection blow molding. Said blends can be processed as a monolayer or can be coextruded with other materials to produce a multilayer structure.

Said blends offer a combination of barrier properties and processibility that is difficult to achieve with polyester alone.

### DETAILED DESCRIPTION

The present invention provides for blends of amorphous nylon copolymers and polyesters. When incorporated as a layer in a packaging structure, said blends exhibit superior barrier to the transmission of gases and a reduced tendency to absorb flavor components from a packaged product.

Suitable amorphous nylon copolymers include hexamethyleneisophthalamide-hexamethylene teraphthalamide copolymer also referred to as nylon 6I/6T. A preferred component of the invention is hexamethyleneisophthalamide-hexamethylene teraphthalamide copolymer that has from about 65 percent to about 80 percent of its polymer units derived from hexamethyleneisophthalamide. Polymers of this kind are available commercially from E. I. DuPont under the trade name “Selar PA” and from EMS Chemie under the trade name “Grivory.” These polymers are considered to be essentially 100% amorphous and thus do not have discreet crystalline melting points. A glass transition temperature of about 125 degrees C. characterizes them.

Suitable polyester polymers include but are not limited to the following: polyethylene terephthalate (PET), polytrimethylene terephthalate (PTT), and polybutylene terephthalate (PBT).

Suitable blends as covered by the present invention contain from about 10 to about 90 percent by weight of amorphous nylon and from about 90 to about 10 percent by weight of polyester. More preferred blends contain from about 30 to about 70 percent by weight of amorphous nylon and from about 70 to about 30 percent by weight polyester. Said blends can be prepared using conventional processing equipment commonly available in the plastics industry including single-screw extruders and twin-screw extruders. The two constituent materials can be melt-processed into a homogeneous blend. The particular polyester resin included in the blend determines the melt-compounding temperature required to produce a homogeneous blend. In general, the temperature should be about 20 to 40 degrees centigrade above the crystalline melting point of the polyester constituent. For blends of amorphous nylon and PET, a melt temperature in the range of about 270 to 290 degrees centigrade is preferred. For blends of amorphous nylon and PTT or PBT, a melt temperature in the-range of about 250 to 270 degrees centigrade is preferred.

Up to 50 percent by weight of the amorphous nylon can be replaced by semi crystalline nylons such as nylon 6, nylon 6/6, nylon 6/12, MXD6 nylon or blends thereof. Similarly, the polyester constituent of the blend may be a single polyester resin as described above or of blends thereof. For effective melt compounding of these blends, the melt temperature should be about 20 to 40 degrees centigrade above the crystalline melting point of the highest melting constituent. Said blends as disclosed offer certain advantages when incorporated as a layer in a packaging structure. In particular, said blends exhibit excellent gas barrier properties and a reduced tendency to absorb flavor components from a packaged product. Conventional polyester resins such as PET, PTT, PBT cannot be effectively processed in the EBM process. These polymers exhibit poor melt strength making it difficult to extrude and blow into a finished container. Moreover, a polyester bottle produced using the EBM process tends to be brittle and weak. The polyester/polyamide blends of the present invention overcome these shortcomings in producing a container using the EBM process. The amorphous nylon contributes melt strength to the blend thereby making it practical to form a finished container. Further, a finished container made from said blends using the EBM process exhibits superior strength versus a container made from polyester alone.

Said blends can be extruded onto a substrate such as paper to produce sheet stock that is suitable for forming into a carton for packaging products including milk and juice. Such cartons offer superior gas barrier and non-scalping performance versus uncoated paper stock. The attendant benefits of improved melt strength and reduced brittleness exhibited by the blends of the present invention offer advantages versus polyester alone as an extrusion-coated layer.

The blends of the present invention can be extruded as a single layer or can be co-extruded with other materials. In EBM containers, and in extrusion coating onto a substrate, it is common to extrude multiple layers. For example, a bottle can be formed that may have an outer layer of polyethylene or polypropylene with an inner layer made from the blends of the present invention. A “tie layer” of polymer may be included in the co-extrusion to bond the inner and outer layers together. In extrusion coating onto paperboard to produce cartons for packaging orange juice, for example, it is common to have as many as 6 layers or more in the co-extruded coating. A blend of the present invention can be incorporated as a layer in a co-extruded coating on paperboard, said blend providing a good barrier against oxygen permeation and a reduced tendency to absorb flavors from a packaged product. When such multilayer co-extruded coatings are used, the top layer is usually polyethylene so that the coated paperboard stock can be formed into a carton and heat-sealed at the seams. Blends of the present invention, alone or in a co-extruded layer, can be extruded into a freestanding sheet by casting onto a belt or roll.

When polyester resins such as PET are processed in extrusion, they are routinely dried to a very low level of moisture just prior to extrusion to prevent hydrolysis of the polymer in the melt. Hydrolysis of the polymer causes a breakdown in molecular weight and a concomitant reduction of mechanical properties in the finished article. An advantage of the present invention is that such extreme drying of the blend just prior to extrusion may not be necessary to ensure that the finished article has sufficient mechanical strength. The amorphous nylon fraction in the blend reduced the effect caused by of hydrolysis of the polyester fraction.

Another advantage of the present invention is the ability to prepare a blend that will exhibit lower melt viscosity than can be achieved with the amorphous nylon alone. By increasing the polyester fraction in the blend above about 30 weight percent, the melt viscosity at any processing temperature will be reduced. This feature of the present technology is useful where improved flow of the melt blend is desired. A specific application where this is useful is in the preparation of plastic caps used in the beverage industry. One commercial process for producing plastic caps is referred to as “in-shell molding”. In this process, a cap body, usually of polyethylene or polypropylene, is premolded. A melted mass of gasket material, usually ethylene vinyl acetate copolymer, is deposited on the inside surface of the top wall of the preformed body and then molded in place by an actuated plunger to form the finished gasket layer. There is interest in the beverage industry to replace the conventional gasket material with a material that can provide good CO2 barrier and non-scalping performance. Amorphous nylon is an especially well-suited material for this application because of its superior barrier properties in a moist environment. In the in-shell molding process, however, it is difficult to form an economically thin layer of amorphous nylon using an actuated plunger because of the high melt viscosity of the polymer. By using a blend of the present invention with a relatively high polyester fraction, low melt viscosity can be achieved without significantly compromising the good barrier properties of the neat amorphous nylon.

It is recognized that the blends of the present invention may optionally be modified with other materials as are commonly used in the packaging industry. These modifiers may include pigments, slip agents, fillers, nano-clays, and oxygen scavengers, among others.

What is claimed is:

1. A composition consisting essentially of
(a) from about 10 to about 90 percent by weight of an amorphous nylon copolymer consisting of hexamethylene isophthalamide-hexamethylene teraphthalamide units and having no measurable melting point; and
(b) from about 90 to about 10 percent by weight of a polyester resin selected from the group including polyethylene terephthalate, polytrimethylene terephthalate, polybutylene terephthalate, and blends thereof.

2. The composition of claim 1 wherein said amorphous nylon copolymer is present in an amount of from about 30 to about 70 percent by weight and said polyester resin is present in an amount of from about 70 to about 30 percent by weight.

3. The composition of claim 2 wherein said hexamethyleneisophthalamide-hexamethylene teraphthalamide has from about 65 to about 80 percent of its polymer units derived from hexamethyleneisophthalamide.

4. The composition of claim 3 wherein up to 50 percent by weight of said amorphous nylon copolymer is replaced with a nylon resin selected from the group including nylon 6, nylon 6/6, nylon 6/12, MXD6 nylon, and blends thereof.

5. The composition of claim 4 wherein said polyester resin is polyethylene terephthalate.

6. The composition of claim 4 wherein said polyester resin is polytrimethylene terephthalate.

7. The composition of claim 4 wherein said polyester resin is polybutylene terephthalate.

8. A blow-molded container having at least one layer consisting essentially of the composition of claims 1, 4, 5, 6 or 7.

9. A plastic sheet having at least one layer consisting essentially of the composition of claims 1, 4, 5, 6 or 7.

10. A plastic film having at least one layer consisting essentially of the composition of claims 1, 4, 5, 6 or 7.

11. A paperboard substrate coated with a least one layer consisting essentially of the composition of claims 1, 4, 5, 6 or 7.

12. A gasket for caps and closures with at least one layer consisting essentially of the composition of claims 1, 4, 5, 6 or 7.

13. The composition of claims 1, 4, 5, 6 or 7 containing at least one modifier selected from the groups including slip agents, fillers, nano-clays, and oxygen scavengers.
